(19) United States
(12) Patent Application Publication
(10) Pub. No.: US 2008/0193669 A1
(43) Pub. Date: Aug. 14, 2008

(54) Synthetic floor plate production line

(76) Inventor: Cyrille Coadou, Beton Bazoches (FR)

Correspondence Address: JAMES RAY & ASSOCIATES, 2640 Pitcairn Road, Monroeville, PA, 15146, US

(21) Appl. No.: 12/012,835

(22) Filed: Feb. 6, 2008

(30) Foreign Application Priority Data
Feb. 6, 2007 (FR) 0753095

(51) Int. Cl. B05C 11/02; B05D 3/12; B05D 3/06

(52) U.S. Cl. 427/532; 427/277; 118/102; 118/620

(57) ABSTRACT

The invention relates to manufacturing a flooring plate out of synthetic material from a raw plate (1). A patina (10) in viscous form is deposited and then spread on a surface (3) of the raw plate, and the patina-coated surface is brushed so as to create visible defects on said surface.

The present invention relates to manufacturing a flooring plate out of synthetic material.

More precisely, the invention relates to a method of manufacturing a flooring plate out of synthetic material starting from a raw plate.

### BACKGROUND OF THE INVENTION

An indoor or outdoor floor or ground covering needs to possess several properties: it must have good durability, in particular to avoid being damaged by impacts from heels passing thereover frequently. The covering must also not be damaged by the weight of furniture or other heavy objects placed thereon, nor must it be damaged by the legs of pieces of furniture such as tables and chairs rubbing against the covering while they are being moved repeatedly. Furthermore, it must be impermeable, it must withstand cleaning materials and dirtying, and it must be easy to clean.

The type of covering that is the most widespread for resistance to abrasion and various chemicals, thereby giving it excellent durability and making it easy to clean is made up of (ceramic) tiles. Because of these qualities and the ability to withstand moisture, tiles are the material of choice for floors in bathrooms and kitchens. However tiles present the disadvantage of being expensive, noisy, and lengthy and difficult to lay: after the surface on which the tiles are going to be laid has been prepared so as to be completely plane and practically free from cracks, it is necessary to use special tools that need to be handled with care in order to cut some of the tiles so as to match the outline of the room, the tiles need to be laid with the help of intermediate spacers, and then the spaces between the tiles need to be filled in with jointing cement.

Another floor covering in widespread use is natural wooden flooring made up of boards or parquet blocks. That is a high-grade material, of pleasing appearance, and of good durability. Nevertheless, like tiling, it constitutes an expensive covering, and it is lengthy and difficult to lay: the surface needs to be prepared, and some of the boards/blocks need to be cut to match the outline of the room (such cutting being performed by sawing, which gives rise in particular to sawdust and shavings), and the various pieces of wood need to be laid accurately.

In parallel with natural floor coverings as constituted by stone, slate, terra-cotta, ceramic, or wood, there are also synthetic coverings. Amongst these synthetic materials, polyvinyl chloride (PVC) and laminates are in the most widespread use, in particular for floor coverings in public spaces, because of low price and easy of laying. Synthetic coverings are also good at withstanding heel impacts and damage from furniture legs. They are easy to lay since they need merely be bonded onto a plane surface, and any cutting that might be needed can be performed with a simple tool, of the cutter type, without generating any dust. In contrast, even if techniques such as embossing do indeed make it possible to create portions in relief on PVC, thereby obtaining a surface state tending to imitate that of tiles or wooden flooring, it is very difficult to give synthetic materials a visual appearance that is sufficiently close to that of stone, slate, terra-cotta, or wooden flooring. Such synthetic materials are therefore often not used by consumers in spite of their low cost.

### OBJECTS AND SUMMARY OF THE INVENTION

The present invention seeks to remedy those drawbacks by proposing a method that makes it possible to impart to the surface of a floor covering plate made of synthetic material, an appearance that imitates as closely as possible the natural appearance of materials such as stone, slate, terra-cotta, or wood.

This object is achieved by the fact that the method of the invention comprises depositing and spreading a patina in viscous form on a surface of said raw plate, and brushing the patina-coated surface so as to create visible faults on said surface.

By means of these provisions, a floor covering is obtained having visible surface defects that are created by brushing the patina, and that reproduce the appearance of stone, slate, terra-cotta, or wood. In addition, the brushing can reveal the portions in relief of the surface of the raw plate, thereby achieving more faithful reproduction. The covering also possesses good properties in terms of impact resistance of the kind inherent to synthetic floor coverings. The Applicant has even found that the patina improves both the ability of the covering to withstand abrasion, and its ability to withstand chemicals, thereby making it easier to clean. Such a floor covering thus constitutes an alternative to stone, slate, terra-cotta, and wooden flooring that is particularly advantageous.

Advantageously, the brushing is performed by at least one brush having flexible bristles.

The bristles must not be too stiff in order to avoid damaging the patina, so they need to be flexible. Simultaneously, they must possess sufficient stiffness to be capable of penetrating into the patina.

Advantageously, after brushing, the method includes exposing the patina on a surface of said raw plate to radiation in order to accelerate drying of the patina.

By way of example, the radiation may be ultraviolet (UV) radiation. Ideally, the composition of the patina is such that it dries very quickly under the action of UV radiation. Speedy drying serves to fix the defects created in the patina by the brushing, before the viscosity of the patina begins to smooth the defects out.

Advantageously, after brushing, the method includes exposing the patina on a surface of said raw plate to hot air in order to accelerate drying of the patina.

Advantageously, the surface of the raw plate on which the patina is deposited presents irregular portions in relief.

These portions in relief, which may be protuberances or roughnesses or a combination of both, thus contribute to imitating the irregular surface of stone, slate, terra-cotta, or wood. Furthermore, after the patina has been spread, the protuberances and the roughnesses are not coated with the same thickness of patina. This affects the appearance of these portions in relief, and contributes to giving the plate the appearance of stone, slate, terra-cotta, or wood.

The invention also relates to apparatus for manufacturing a flooring plate out of synthetic material starting from a raw plate.

According to the invention, the apparatus comprises means for depositing and spreading a patina in viscous form on a surface of said raw plate, and means for brushing said patina-coated surface in such a manner as to create visible defects on said surface.

Advantageously, the means for depositing and spreading the patina on a surface of said raw plate comprise at least one applicator roller.

The use of an applicator roller makes it easier to deposit a quantity of patina that is as uniform as possible over the entire surface of the plate.

Advantageously, the means for brushing the surface of the raw plate coated in said patina comprise at least one brush mounted to rotate about an axis of rotation that is substantially vertical.

The use of a brush mounted to rotate enables the bristles of the brush to sweep effectively over the entire surface of the patina covering the plate, so that, by virtue of their flexibility, the bristles create defects in the patina that are distributed uniformly over the entire surface of the plate. In parallel, because of the partially random nature of the deformation of the bristles when they come into contact with the patina, the defects created in the patina vary from one plate to another. This random nature contributes to ensuring that the surfaces of the plates at the outlet from the apparatus of the invention are not completely identical. This contributes to giving the plates the appearance of stone, slate, terra-cotta, or wood.

The invention can be well understood and its advantages appear better on reading the following detailed description of an embodiment given by way of non-limiting example. The description refers to the accompanying drawings, in which:

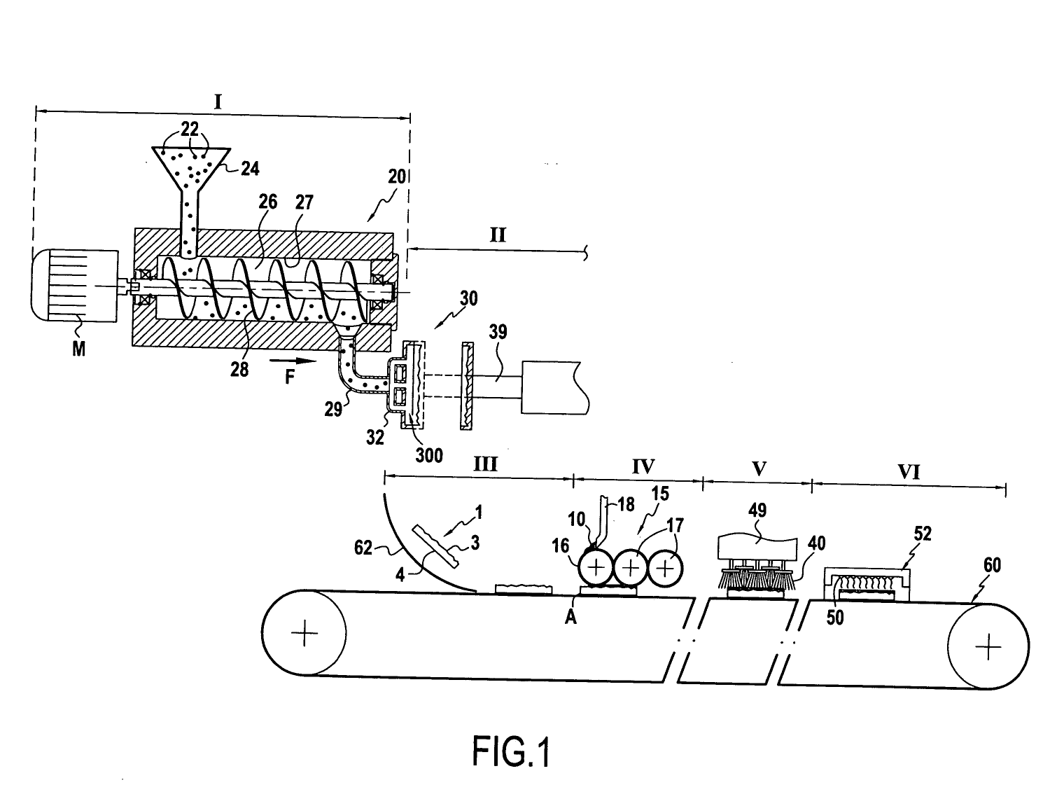

FIG. 1 is a diagram showing an apparatus of the invention;

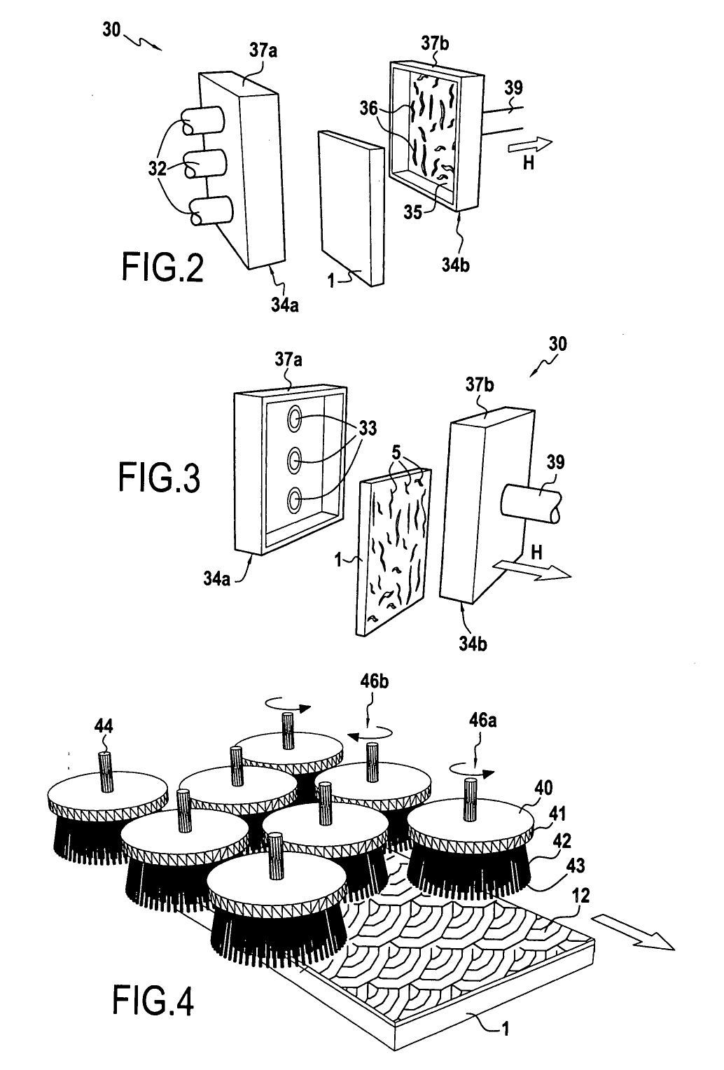

FIGS. 2 and 3 are diagrams showing the formation of a plate in a mold;

FIG. 4 is a perspective view showing the brushing of the patina of a plate by rotary brushes;

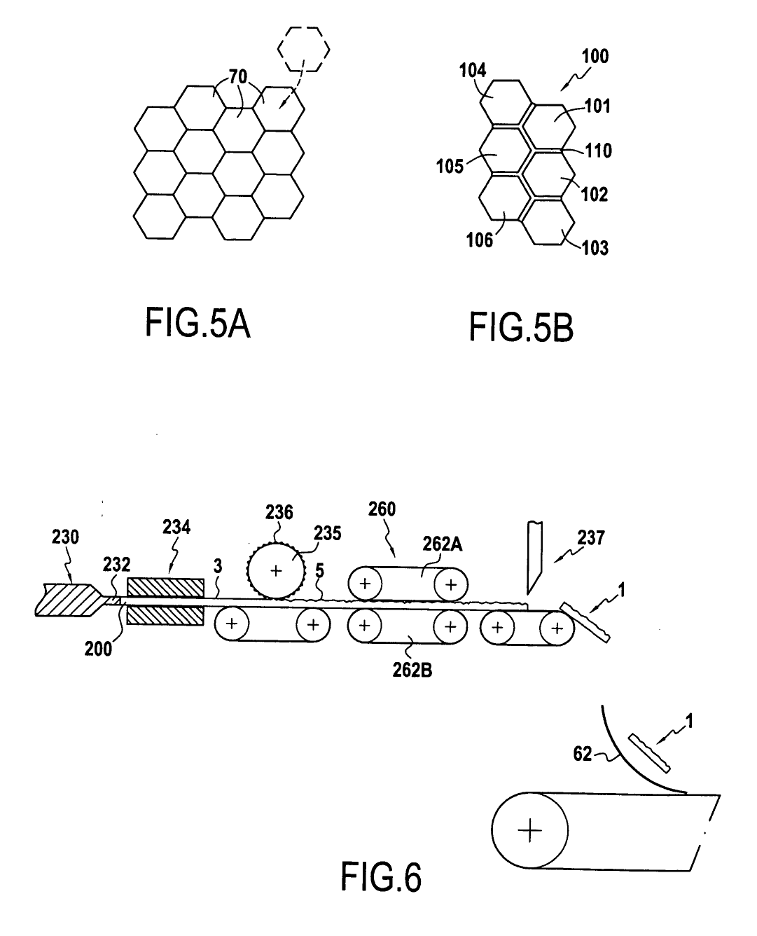

FIG. 5A shows the arrangement of hexagonal ground plates constituting a covering;

FIG. 5B shows a ground plate having the appearance of a plurality of juxtaposed hexagonal ground plates; and

FIG. 6 shows how a plate can be manufactured by extrusion and calendering.

### MORE DETAILED DESCRIPTION

FIG. 1 shows an apparatus in which the various steps of the manufacturing method of the invention are performed. In a step I, there is an injector 20. This injector is of conventional design, and only its general operation is described. Granules 22 of synthetic material, e.g. granules that at least approximately spherical in shape, are deposited in a feed hopper 24 that communicates via its narrow end with the inside of the injector 20. By way of example, the synthetic material is polyvinyl chloride (PVC). The synthetic material may also be a polyurethane resin, in particular a urethane-based thermoplastic elastomer (thermoplastic polyurethane or TPU). The polyurethane resin may be filled with various additives, in particular with kaolin, in order to modify its physical and mechanical properties. TPU possesses a better lifetime as a floor covering than does PVC, but it is more expensive. The synthetic material may also be a combination of PVC and of TPU, in particular in proportions of 95% and 5% respectively or of 5% and 95%, respectively. The inside of the injector 20 is in the form of a cylindrical bore 26 having a circumferential wall 27 in which a wormscrew 28, driven in rotation by a motor M, revolves about a horizontal axis that coincides with the axis of symmetry of the bore 26. The circumference of the wormscrew 28 practically touches the wall 27 of the bore 26 such that by revolving, the wormscrew 28 pushes the granules 22 in the direction of arrow F, i.e. to the right in FIG. 1. A duct 29 situated at the end of the bore 26 remote from the end near where the hopper 24 is situated opens out into the bore 26. The granules 22 (possibly melted if heater means are situated on the injector 20, see below) as pushed by the wormscrew 26, drop into the duct 29.

The injector 20 can develop pressure lying in the range 5 (metric) tonnes (T) to more than 1000 T for manufacturing plates of large area (several square meters).

In a step II, there is a mold 30, that can also be seen in FIGS. 2 and 3, and that is used for molding the raw plate 1. The mold 30 is rectangular in shape, however it could equally well be square or hexagonal in shape, depending on the shape desired for the plate. Its shape may be suitable for enabling a plate to be molded that constitutes an assembly of elements separated by grooves giving the appearance of joints, with one such plate 100 being visible in FIG. 5. The duct 29 having one of its ends opening out into the bore 26, is extended at its other end by channels 32 that open out via orifices 33 into a first portion 34a of the mold 30. At its periphery, this first portion has a first edge 37a. A second portion 34b of the mold 30 has a second edge 37b at its periphery. The second portion 34b of the mold 30 is designed to co-operate with the first portion 34a. During co-operation (closed position), the first edge 37a is in contact with the second edge 37b such that the two mold portions as assembled together in this way define a closed volume 300 (FIG. 1) that is connected to the outside of the mold solely via the channels 32 and via one or more holes (not shown) for venting air while the mold 30 is being filled. This closed volume 300 corresponds to the volume of the raw plate 1 that is to be molded in the mold 30, and specifically it corresponds to the volume of a rectangular parallelepiped. The first portion 34a of the mold 30 is stationary, and the second portion 34b is moved into the closed position by moving in translation under thrust from an actuator 39.

The inside face of the first portion 34a is plane, with the exception of the orifices 33, and it is rectangular. The inside face 35 of the second portion 34b is plane or it includes surface irregularities 36, as shown in FIG. 2. The inside face 35 is rectangular. By using heater means (not shown), the granules are melted so as to form a plastics material that penetrates into the mold 30 in a pasty or liquid state, and fills the entire closed volume 300 defined by the first portion 34a and the second portion 34b (these heater means may be situated on the injector 20 or on the duct 29). While the closed volume 300 is being filled, the actuator 39 exerts pressure so as to keep the first portion 34a and the second portion 34b in the closed position, and possibly so as to move these portions closer together so that the closed volume 300 corresponds to a desired volume. Once the compacted plastics material has been compacted in the mold to form the plate 1, and once the mold has cooled down, the material is unmolded therefrom.

For this purpose, the actuator 39 moves the second portion 34b of the mold 30 in translation along arrow H (to the right in FIGS. 3 and 4), so that the second portion 34b moves away from the first portion 34a, thereby releasing the plate 1. When the inside face 35 of the second portion 34b of the mold 30 possesses surface irregularities 36, these irregularities cause irregular portions in relief 5 to be formed on one of the surfaces 3 of the raw plate 1 while the plate 1 is being made in the mold 30. The face 4 of the raw plate 1 that is opposite from the surface 3 is plane and smooth. It should be understood that the drawings show a mold having a cavity of generally rectangular shape for reasons of simplicity. Other shapes could be envisaged, as mentioned above, and the inside face 35 may have regular ribs so as to form grooves in the plate 1 that imitate joints. Furthermore, the thickness of the plate is exaggerated in order to clarify the drawing.

Alternatively, instead of using a mold 30, the apparatus could include an extruder 230 suitable for extruding a strip 200 of synthetic material, as shown in FIG. 6. In conventional manner, the synthetic material is introduced into the extruder 230 and leaves it via the outlet orifice of an extruder die 232 of the extruder 230. Where necessary, the extruded strip 200 then passes through a shaper 234 that cools it and stabilizes its shape. It then passes under a cylindrical calender 235 situated downstream from the shaper 234 in the drive direction of the strip 200. The strip 200 is driven by means of a puller 260 situated downstream from the calender 235 and comprising two puller caterpillars 262A and 262B that co-operate respectively with the top face and with the bottom face of the strip 200. The calender 325 is in the form of a cylinder of horizontal axis perpendicular to the drive direction of the strip 200. On its surface, the calender 235 possesses protuberances 236 that form irregular portions in relief 5 on the surface 3 of the top face of the strip 200 as the strip 200 passes under the calender. The strip 200 is preferably not completely cooled down on leaving the shaper 234, thereby facilitating the formation of such portions in relief by the calender 235. The strip 200 is then cut up into plates 1 by a cutter 237 situated downstream from the puller 260 in the drive direction of the strip 200.

In a step III, the plate 1, that has been released from the mold 30, or alternatively that has been delivered by the cutter 237 (FIG. 6), is now cool, and is delivered by suitable means, e.g. a ramp 62, onto a conveyor 60, such that the surface 3 of the plate 1 faces upwards, i.e. the face 4 of the raw plate 1 is in contact with the conveyor 60.

In a step IV, the plate 1 is delivered by the conveyor 60 to means 15 for depositing and spreading a patina 10 on the surface 3 of the raw plate 1. By way of example, the patina comprises colorless or colored surface coating (varnish), pigments or coloring agents (e.g. red, blue, gray, green), and a solvent. By way of example, the patina has one of the following names sold under the trademark “Syntilor-Blanchon”: Basalmine (1000 grams (g) of colorless coating, 16 g of red coloring agent, 250 g of blanchon coating, 5000 g of chlorine); Autumn (1200 g of blanchon coating, 12 g of black coloring agent, 14 g of red coloring agent, 5000 g of chlorine); Terra-cotta (2000 g of blanchon coating, 200 g of black coloring agent, 10 g of chloride; Stone (2000 g of blanchon coating, 5000 g of chloride); Gazania (2000 g of satin-finish bondex-oak-722 coating, 5000 g of chloride, black coloring agent), Rustic Oak. The means 15 are constituted by one or more rollers of axes A that are parallel to the mean plane of the surface 3 and perpendicular to the drive direction of the conveyor 60. The mean plane of the surface 3 is defined as the plane parallel to the face 4 situated at a distance from the face 4 that is the average of the distances of each of the points on the surface 3 from the face 4. At least one of these rollers is an applicator roller 16. In FIG. 1, the means 15 comprise an applicator roller 16 and two smoothing rollers 17. The patina 10, in a form presenting viscosity that is sufficiently low to approach the liquid state, runs out from a pipe 18 having an outlet that is advantageously of width that is slightly less than the length of the roller 16, and it becomes deposited on the top portion of the application roller 16, which roller is of a length that is slightly greater than the dimension of the plate 1 along the axis A. The applicator roller 16 rotates about its axis A, and in rotating it entrains the patina 10, thereby depositing it on the surface 3. The distance between the roller 16 and the mean plane of the surface 3 is such that when the plate passes under the roller 16, a quantity of patina 10 that is just sufficient for forming a film over the entire surface 3 of the raw plate 1 and for covering the irregular portions in relief 5 is deposited on the surface. Thus, the roughnesses of the surface 3 are filled with the patina 10. Where appropriate, one or more smoothing rollers 17 situated downstream from the applicator roller 16 in the drive direction of the conveyor 60 remove any excess patina 10 from the surface 3, and smooth the patina 10 so that its top surface becomes parallel to the mean plane of the surface 3. The rollers 17 and 16 are preferably rotated automatically. They could also be turned manually.

The patina 10 may alternatively be deposited as a plurality of successive layers, the layers possibly having different compositions. Under such circumstances, the means 15 for depositing and spreading the patina comprise in succession as many groups as there are layers of patina to be deposited, where each group comprises a pipe 18, an applicator roller 16, and smoothing rollers 17.

In addition or as an alternative to the roller 16, the means for depositing the patina 10 on the surface 3 of the raw plate 1 may comprise at least one sprayer that sprays the patina 10 onto the surface 3. In a variant, the patina may also be deposited by hand, with the patina being spread over the entire surface 3 by circular movements.

In a step V, the patina 10 is brushed. As shown in FIG. 1, the raw plate 1 with its surface 3 coated in the patina 10 is subsequently delivered by the conveyor 60 to brush means situated downstream from the means 15. FIG. 4 shows the brush means that comprise at least one brush 40 having a spindle 44 that is suitable for rotating about its axis of symmetry that extends substantially perpendicularly to the mean plane of the surface of the raw plate. The spindle 44 is thus substantially vertical. In FIG. 4, the thrust means comprise six brushes 40. These brushes perform mechanical brushing of the patina 10 covering the surface 3 of the raw plate 1. The brushes 40 are rotated by a drive apparatus 49 that is stationary relative to the support of the conveyor 60, i.e. the conveyor 60 moves relative to the drive apparatus 49 and relative to the axes of rotation of the brushes 40. Each brush 40 thus comprises a spindle 44 and a plate 41 fastened beneath the spindle 44. Each plate 41 has bristles 42 on its bottom face, which bristles are fastened by means of their top ends. At rest, the bristles 42 extend substantially perpendicularly to the plate 41. The bristles 42 are of substantially the same length, and at rest they are substantially parallel to one another such that their bottom ends 43 occupy a common plane parallel to the plate 41, to the mean plane of the surface 3 of the raw plate 1, and to the top surface of the patina 10. The brushes 40 are circular, i.e. the plates 41 are circular and, over each plate 41, the bristles 42 are distributed with circular symmetry about the axis of revolution of the brush 40. The brushes 40 of the brush means could equally well have a shape other than circular, for example they could be square, oval or rectangular. The bristles 42 of the brushes 40 are flexible: they must not be too stiff in order to avoid damaging the patina. Nevertheless, they must possess sufficient stiffness to enable them to penetrate into the patina 10. By way of example, the bristles 40 may be made of horsehair having a length of 30 millimeters (mm) to 40 mm. They may also be made of nylon with a length of 30 mm to 40 mm, or of silk with a length of about 5 mm.

The distance between the brushes 40 and the mean plane of the surface 3 is such that when the raw plate 1 passes under the brushes 40, and as the raw plate 1 is driven by the conveyor 60, the bottom ends 43 of the bristles 42 of the brushes penetrate into the layer of patina 10, thereby creating visible defects 12 in the patina 10, and thus providing a satisfactory imitation of the surface of a flooring tile or of wooden flooring. The visible defects as created in this way are of a depth that depends on the stiffness and the length of the bristles 42, and on the distance between the brushes 40 and the mean plane of the surface 3.

All of the brushes 40 may revolve in the same direction, or the brush means may include at least two contrarotating brushes 46a, 46b, i.e. the brush 46a rotates in the opposite direction to the brush 46b. As shown in FIG. 4, the brushes 40 are disposed in a staggered configuration and they cover the entire surface of the raw plate 1. The brushes 40 may also be disposed at the nodes of a square mesh, e.g. a mesh that is oriented parallel to the travel direction of the conveyor 60. The above-described brush means perform brushing in automatic manner. The brushing could also be performed manually. The bristles 42 describe circular paths on the patina. The brush means could equally well be such that the paths followed by the bristles 42 are rectilinear or random.

In a step VI, the raw plate 1 is taken by the conveyor 60 to means that emit radiation suitable for accelerating the drying of the patina 10 coating the surface 3 of the raw plate 1. These means are constituted by one or more radiation emitters 50 situated in a tunnel 52. The radiation emitted by the emitter 50 may be ultraviolet (UV) radiation, or any other radiation suitable for accelerating the drying of the patina 10. The raw plate 1 is taken by the conveyor 60 through the tunnel 52 where it spends the time needed to ensure that the patina 10 is dried. Thereafter, the conveyor takes the raw plate 1 out from the tunnel 52.

Alternatively, the patina 10 can be dried by being exposed to hot air coming from means for heating air (e.g. a hot air blower or an oven), or by being left in the open air.

Downstream from the tunnel 52 in the travel direction of the conveyor 60, the raw plate 1 may, where appropriate, be taken by the conveyor 60 to a station suitable for receiving the plate 1 and for coating the surface 3 of the raw plate 1 with a layer of colorless varnish suitable for strengthening the abrasion resistance of the patina 10 to abrasion.

At the end of the manufacturing method, raw plates 1 coated in the patina 10 are ready for laying on a floor as flooring plates 70. FIG. 5A shows the arrangement on the floor of such flooring plates 70 when they are hexagonal in shape. FIG. 5B shows a plate 100 having a perimeter corresponding to the perimeter of a figure made up of six regular hexagons 101, 102, 103, 104, 105, 106 that are disposed as follows: the first hexagon 101 has one side in common with the second hexagon 102, which itself has one side in common with the third hexagon 103 such that the three hexagons 101, 102, and 103 are in alignment. The fourth hexagon 104 is disposed so as to have one side in common with the first hexagon 101, the fifth hexagon 105 is disposed so as to have one side in common with the fourth hexagon 104, one side in common with the first hexagon 101, and one side in common with the second hexagon 102. The sixth hexagon 106 is disposed so as to have one side in common with the fifth hexagon 105, one side in common with the second hexagon 102, and one side in common with the third hexagon 103.

The plate 100 constitutes a single piece made in a mold 30 having the shape of this plate. Furthermore, the face 35 of the mold has portions in relief that serve, during manufacture of the plate 100, to form grooves along each of the common sides 110 between pairs of hexagons 101, 102, 103, 104, 105, or 106, these grooves having the appearance of joints. Thus, once laid on the floor, the plate 100 appears to be made up of six hexagons interconnected by joints, whereas in fact it is a single piece. The floor can thus be covered by a plurality of juxtaposed plates 100, thereby accelerating laying and limiting the number of joints that need to be made between the plates, since each plate 100 has an area that is greater than that of a single hexagon.

In similar manner, it is possible to manufacture a plate 100 in a suitable mold that has the appearance of a plurality of juxtaposed elements that are square in shape or rectangular in shape.

The above-described method of manufacturing plates 1 makes use of an injection method at high pressure or at low pressure. It is also possible to manufacture plates using other methods, for example low pressure casting: when the material constituting the plate is the result of a reaction between two components, e.g. a hardener and an isocyanate (possibly together with a coloring agent), the two components may be poured simultaneously into an open horizontal mold having surface irregularities on its face constituting its bottom.

What is claimed is:

1. A method of manufacturing a flooring plate out of synthetic material, starting from a raw plate (1), the method comprising depositing and spreading a patina in viscous form on a surface of said raw plate, and brushing the patina-coated surface so as to create visible faults on said surface.

2. A method according to claim 1, wherein said patina comprises a surface coating, coloring agents or pigments, and a solvent.

3. A method according to claim 1 wherein the brushing is performed by at least one brush having flexible bristles.

4. A method according to claim 1 wherein the brushing is performed manually.

5. A method according to claim 3 wherein the brushing is performed mechanically with the help of at least one brush that is rotary about an axis of rotation that is substantially perpendicular to the surface of said raw plate.

6. A method according to claim 1 including after brushing, exposing the patina on a surface of said raw plate to radiation in order to accelerate drying of the patina.

7. A method according to claim 1 including, after brushing, exposing the patina on a surface of said raw plate to hot air in order to accelerate drying of the patina.

8. A method according to claim 1 wherein said raw plate is obtained by molding.

9. A method according to claim 1 wherein, prior to depositing the patina, irregular portions in relief are formed on the surface of said raw plate onto which the patina is to be deposited.

10. Apparatus for manufacturing a flooring plate out of synthetic material from a raw plate, the apparatus comprising at least one applicator for depositing and spreading a patina in viscous form on a surface of said raw plate, and at least one brush for brushing said patina-coated surface in such a manner as to create visible defects on said surface.

11. Apparatus according to claim 10 including a mold having an inside face presenting surface irregularities suitable for forming irregular portions in relief on a surface of a raw plate made in the mold.

12. Apparatus according to claim 10 including an extruder suitable for extruding a strip of synthetic material for forming a raw plate, and a calender suitable for forming irregular portions in relief on a surface of the strip extruded by the extruder.

13. Apparatus according to claim 10 wherein said at least one applicator is chosen among a roller and a sprayer.

14. Apparatus according to claim 10 wherein at least one brush is mounted to rotate about an axis of rotation that is substantially vertical.

15. Apparatus according to claim 14 comprising at least two contrarotating brushes for brushing said patina-coated surface.

16. Apparatus according to claim 14 comprising a plurality of rotary brushes each having an axis of rotation that is substantially vertical for brushing said patina-coated surface, the brushes being disposed in a staggered configuration.

17. Apparatus according to claim 10 further comprising at least one radiation emitter for exposing the surface coated with patina to radiations in order to accelerate drying of the patina.

18. Apparatus according to claim 10 further comprising a heater for exposing the surface-coated with patina to said hot air in order to accelerate drying of the patina.

19. Apparatus according to claim 10 including a conveyor suitable for supporting the raw plate, wherein the at least one applicator and the at least one brush are disposed in successive stations on the path of the conveyor.
